(19) United States
(12) Patent Application Publication
(10) Pub. No.: US 2010/0306024 A1
(43) Pub. Date: Dec. 2, 2010

(54) SYSTEM AND METHOD OF PROVIDING AN ONLINE SURVEY AND SUMMARIZING SURVEY RESPONSE DATA

(75) Inventor: Christopher John Ryan, Vancouver (CA)

Correspondence Address: KNOBBE MARTENS OLSON & BEAR LLP, 2040 MAIN STREET, FOURTEENTH FLOOR, IRVINE, CA, 92614, US

(73) Assignee: VISION CRITICAL COMMUNICATIONS INC., Vancouver (CA)

(21) Appl. No.: 12/475,355

(22) Filed: May 29, 2009

(51) Int. Cl. G06Q 10/00; G06Q 99/00; G06F 3/048

(52) U.S. Cl. 705/10; 715/841; 705/1.1

(57) ABSTRACT

Embodiments disclosed herein include systems and methods which allow for the creation of online surveys in which thematically-related questions are grouped together as meta-questions to reduce the perceived and/or actual time and effort needed to complete the survey. Further disclosed embodiments provide the ability to provide a summary display of survey response data in an aggregate format such as a sentence (or pseudo-sentence) which summarizes answers given to a series of thematically related questions.

### BACKGROUND OF THE INVENTION

1. Field of the Invention

This application relates to the capture and summarization of response data from users in online surveys. In particular, the application relates to a system and method for presenting survey questions in thematic groupings which allow for quicker and easier responses from users and also allow for a larger number of survey questions to be grouped together without need to refresh the browser content.

2. Description of the Related Technology

Traditionally, surveys of public opinion were conducted over the telephone. The survey was typically conducted by a survey taker who presented a series of questions to survey participants and recorded the answers given to the questions. As computer technology evolved and the Internet became more ubiquitous in our daily lives, survey providers began developing software which allowed for surveys to be conducted online via web pages accessed through Internet browsing software. These online survey applications were typically designed to proceed in the same manner as telephonic surveys, with online users asked to answer questions presented sequentially, with the answers recorded by the survey software. Existing techniques for conducting online surveys are inadequate and suffer from various problems related to the way data is presented to and collected from survey participants. As a result, improved online survey systems and methods are needed.

### SUMMARY OF CERTAIN INVENTIVE ASPECTS

The system, method, and devices of the present invention each have several aspects, no single one of which is solely responsible for its desirable attributes. Without limiting the scope of this invention, several of its features will now be discussed briefly.

A first inventive aspect is an online survey system. The online survey system may include data storage configured to store data indicative of a plurality of survey questions, wherein at least some of the plurality of survey questions are thematically grouped into meta-questions. The system may further include a plurality of displayable panels having an expanded state and an unexpanded state. The panels each correspond to one of the meta-questions. The panels are configured to enter an expanded state and provide access to its meta-question in response to a user selection of the panel and receive data inputs indicative of responses to the meta-question. The panels are further configured to generate summary data indicative of the received responses and display the summary data on the panel in both an expanded and unexpanded state. A completion indicator may be updated based on the user input; and the panel may enter an unexpanded state when a selection of another panel is received by the online survey system.

A second inventive aspect is a computer-implemented method for presenting survey questions to survey respondents. The method includes grouping questions thematically into a plurality of meta-questions and generating a plurality of tiled controls which provide access to each meta-question. The tiled controls have an expanded view and an unexpanded view. The method further includes receiving an input selection of one of the tiled controls. The selected tiled control is set to the expanded view to display its associated meta-question for user response. Non-selected tiled controls are set to the unexpanded view.

### BRIEF DESCRIPTION OF THE DRAWINGS

FIG. 1 is a top level diagram of a system for providing an online survey in accordance with one or more embodiments.

FIG. 2A is a block diagram providing a more detailed view of the survey module shown in FIG. 1.

FIG. 2B is an example of XML configuration data in accordance with one or more embodiments.

FIG. 3 is a block diagram providing a more detailed view of a panel as shown in FIG. 2A.

FIG. 4 is a block diagram providing a more detailed view of a content and control portion the panel shown in FIG. 3.

FIGS. 5A-5E are examples of tiled controls with completion indicators in expanded and unexpanded views.

FIGS. 6A-6D are examples of tiled controls which provide generated summaries based on responses provided by survey respondents.

FIG. 7 is a flowchart illustrating a process by which the survey system may generate and conduct an online survey in accordance with one or more embodiments.

FIG. 8 is a flowchart of a process by which a summary of a response to a meta-question is generated for display to a user.

### DETAILED DESCRIPTION OF CERTAIN INVENTIVE EMBODIMENTS

Embodiments disclosed herein include systems and methods which allow for the creation of online surveys in which thematically-related questions are grouped together as “meta-questions” to reduce the perceived and/or actual time and effort needed to complete the survey. By reducing the perceived and/or actual time and effort needed to complete the survey, it is more likely that a given survey respondent will take the time to more accurately answer all of the survey questions, thereby yielding a more complete and accurate data set. Further disclosed embodiments provide the ability to provide a summary display of survey response data in an aggregate format such as a sentence (or pseudo-sentence) which summarizes answers given to a series of thematically related questions. By providing a summary display of response data, a survey respondent is able to more easily verify the accuracy and completeness of their answers prior to submitting their survey response. Still additional aspects provide an improved progress indication technique which provides the survey respondent with improved information relating to his or her progression through the questions in the survey.

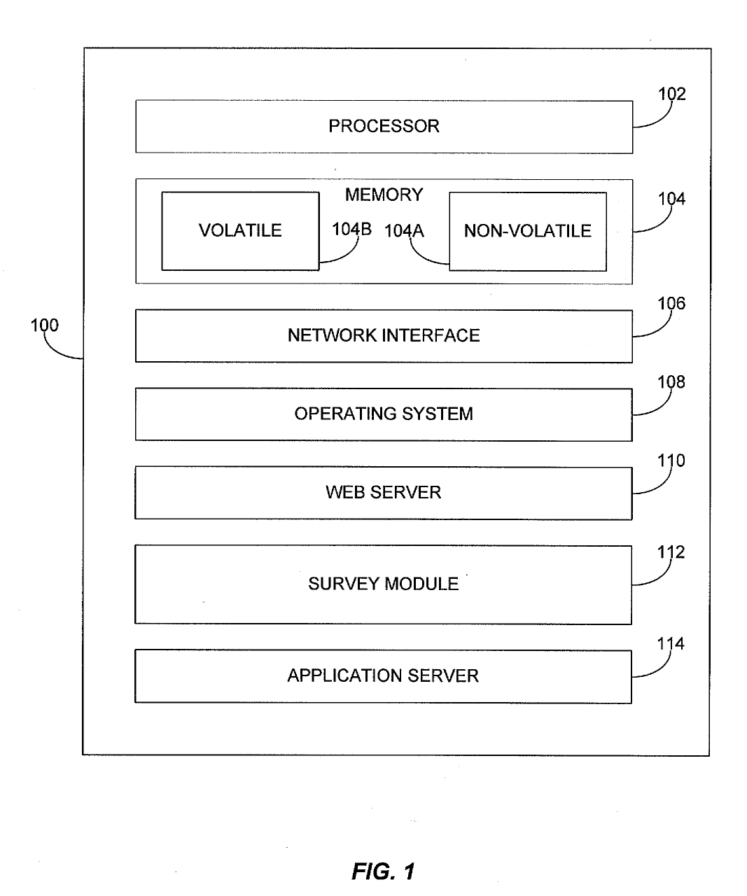

FIG. 1 is a block diagram of a computer system 100 for providing an online survey to survey respondents. The computer system 100 may generally take the form of computer hardware configured to execute certain processes and instructions in accordance with one or more embodiments described herein. The computer hardware may be a single computer or it may be multiple computers configured to work together. The computer system 100 includes a processor 102. The processor is generally configured to execute computer instructions to carry out certain tasks related to the providing online surveys to survey respondents. The processor 102 may be a standard personal computer processor such as those distributed by Intel, Advanced Micro Devices or Motorola. The processor 102 may also be a more specialized processor tailored for survey processes and programs. The system 100 may also include a memory 104. The memory 104 may include volatile memory 104A such as some form of random access memory. The volatile memory 104A may be configured to load executable software modules into memory so that the software modules may be executed by the processor 102 in a manner well known in the art. The software modules may be stored in a non-volatile memory 104. The non-volatile memory may take the form of a hard disk drive, a flash memory, a solid state hard drive or some other form of non-volatile memory.

The computer system 100 also may include a network interface 106. The network interface may take the form of a network interface card and its corresponding software drivers and/or firmware configured to provide the system 100 with access to a network (such as the Internet, for example). An operating system 108 is also included in the computer system 100. The operating system 108 may be a well-known general operating system such as Linux, Windows, or Mac OS X which is designed to provide a platform from which computer software applications may be executed by the processor 102. Alternatively, the operating system 108 may also be a special purpose operating system designed specifically for the online survey environment.

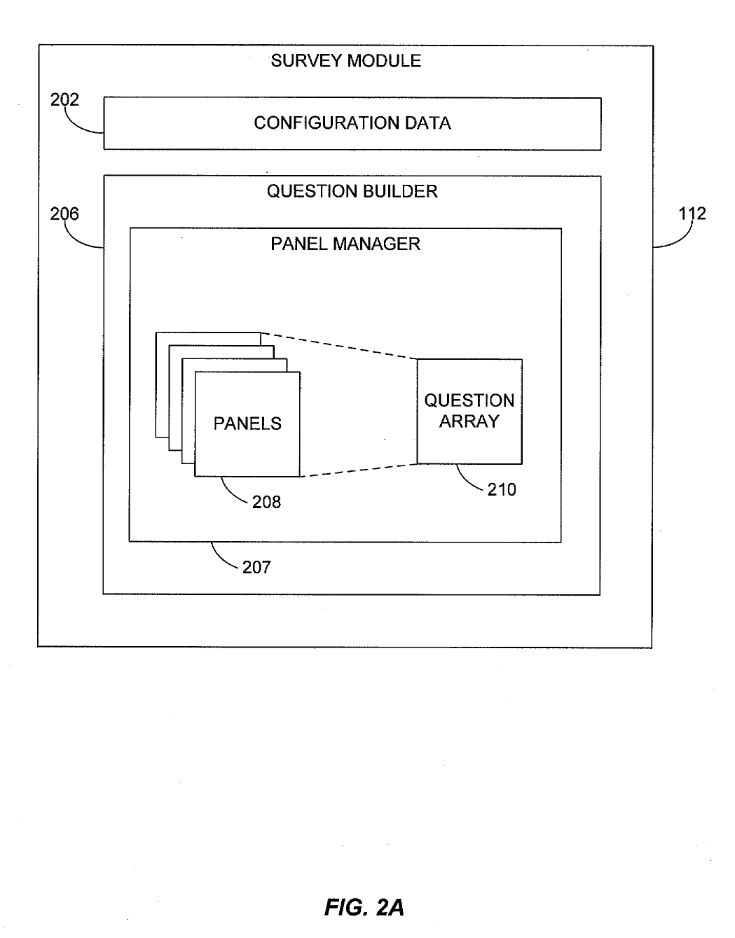

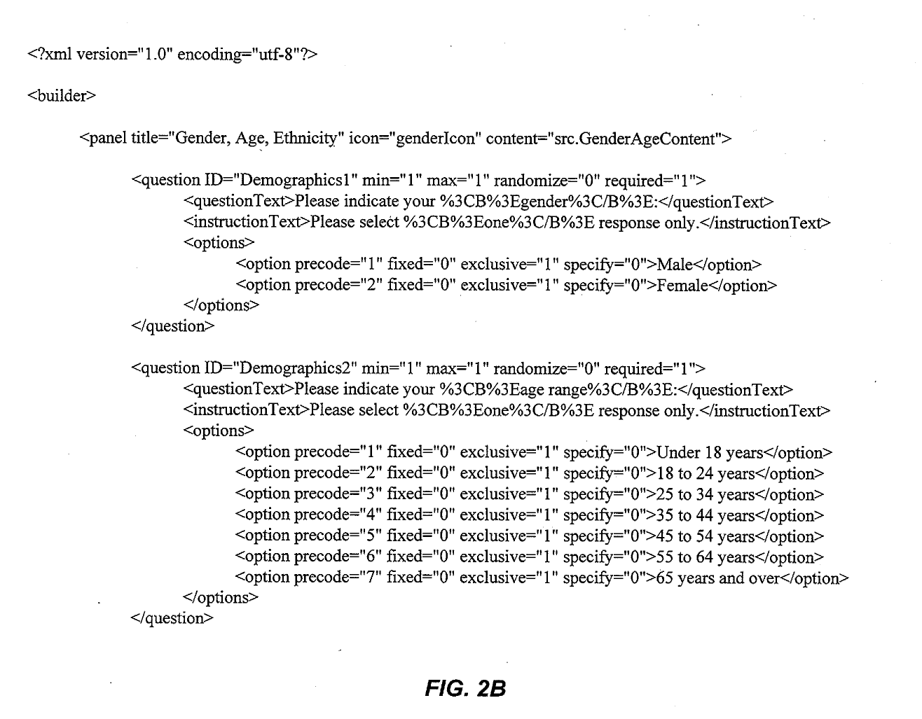

Running on the operating system 108 may be web server software 110. The web server software 110 may be a standard off the shelf web server product such as Apache, Internet Information Server, or some other web server software. Alternatively, the web server may form a part of the operating system 108, or it may be a specialized HTTP server which is configured specifically to deliver survey web pages to browsing software via a network such as the Internet, or some other local area network or wide area network. The web server software 110 may be stored in the memory 104 for access by the processor 102 to execute on the operating platform provided by the operating system 108. The computer system, 100 further includes a survey module 112. The survey module 112 is may include computer hardware and/or software which is configured to provide online survey applications which may run on an application server 114, on the web server 110, or both. The survey module generally is configured to allow for the creation and distribution of online surveys to survey respondents as will be discussed in detail below in connection with FIGS. 2-4. In some embodiments, the survey module may include a web application such as a Flash-based application may be loaded into a web browser running on a remote computer.

Turning to FIG. 2A, a more detailed view of the survey module 112 is provided. As shown, the survey module 112 may include configuration data 202. The configuration data 202 may take the form of an eXtensible Markup Language (“XML”) configuration file which includes data that may be used by the survey module 112 to create an online survey in accordance with one or more embodiments. The configuration file may include data which specifies the types of questions to be asked of survey respondents during an online survey. The configuration data may further include data indicative of more general themes with which the questions may be associated. For example, questions relating to a survey respondent's gender, age, and ethnicity may be associated with a “demographic” theme. Questions relating to a survey respondent's television viewing habits may be associated with a “television” theme. Question data may include both question text, and answer options. For example, a particular question may have a specific set of required answers from which a survey respondent may choose. These answers may also be included in the configuration data 202.

The configuration data may further include instruction data which provides information to survey respondents on how a particular question should be answered. For example, for a question such as “What is the highest level of education you have completed?”, an instruction may be associated with the question which indicates to the survey respondent that only a single response among a plurality of choices should be selected. The configuration data 202 may further include graphics data which is associated with the questions. For example, icons which are indicative of a particular theme may be included in the configuration data. FIG. 2B provides an example of a portion of an XML configuration file which includes the various types of data discussed above.

Returning to FIG. 2, the survey module 112 may also include a question builder 206. Because online surveys include questions that are typically posed to survey respondents, a set of questions may be created from the configuration data 202 by the question builder 206. In some embodiments, the question builder 206 may be a top level class in an object-oriented software application. The question builder 206 may be configured to provide input and output of XML-formatted data which is stored in a database. In one particular embodiment, the question builder 206 may be configured to load the configuration data 202 and then provide the configuration data to a panel manager 207. The panel manager 207 may be a subclass of the question builder, and may be generally configured to part the configuration data in order to generate a series of question panels 208 for display to survey respondents via the web server 112. In one specific embodiment, the panel manager may deserialize the question definitions provided in the configuration data 202 into an array 210 of question objects which map to standard survey question types. The objects in the question array 210 may then be associated with specific panels 208 based on their subject matter and theme. As a result, each of the question panels 208 may each include one or more questions which are related to a specific theme or topic. Questions are grouped thematically in order to provide the survey respondent with a sense of coherence and unity as they proceed through the survey.

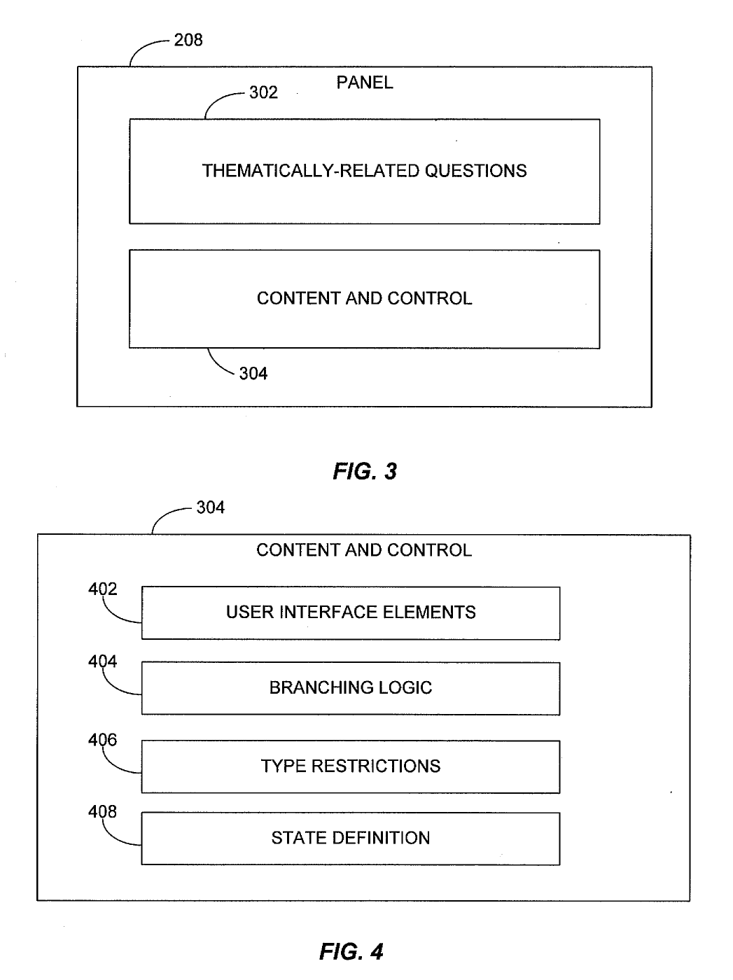

Turning now to FIG. 3, a block diagram provides a more detailed example of one of the panels 208 shown in FIG. 2A. As discussed above, the panel 208 may include thematically-related questions 302 which may be drawn from an array of question objects generated by the question builder 206. In some embodiments, the panel may be a class in an object-oriented programming environment, with each panel being a self-contained unit within the top-level question builder. The panel class may be configured to handle various aspects of the survey process relating to the panel. For example, in some embodiments, the panel class is configured to manage its window layout, including attributes such as a title bar, associated icons, opening and closing animations, and question validation. The panel 208 may further include a content and control object 304 as shown in FIG. 3. The content and control objects typically provide functionality by which the layout and behavior of user interface components such as menus and buttons may be defined.

Turning to FIG. 4, a more detailed view of the content and control object 304 is provided. As shown, the control and control object may include various sub-components which provide survey-related functionality. In the example shown in FIG. 4, the content and control object 304 may be configured to generate user interface elements 402 and bind the thematically related questions 302 in the panel object 208 to the user interface elements 402 which are associated with the panel 208. In some embodiments, the content and control objects 304 may provide branching logic 404 which allows for questions to be hidden or shown based on responses to previous questions. Thus, if a first question presented to a survey respondent is “Do you own a car?” and the inputted answer is “No,” then a second question of “What kind of car do you own?” may not be presented.

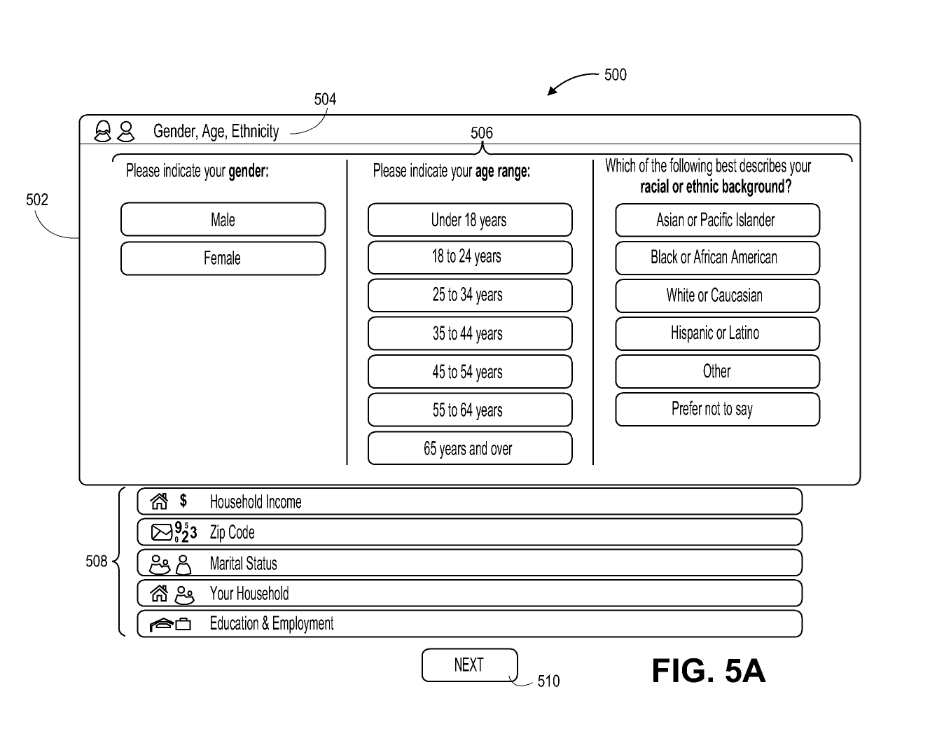

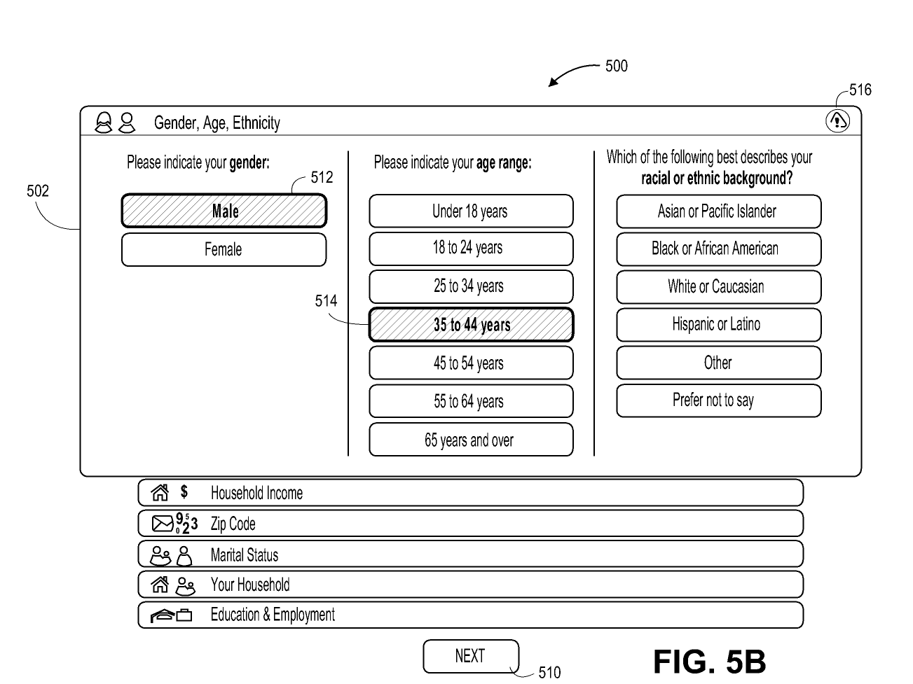

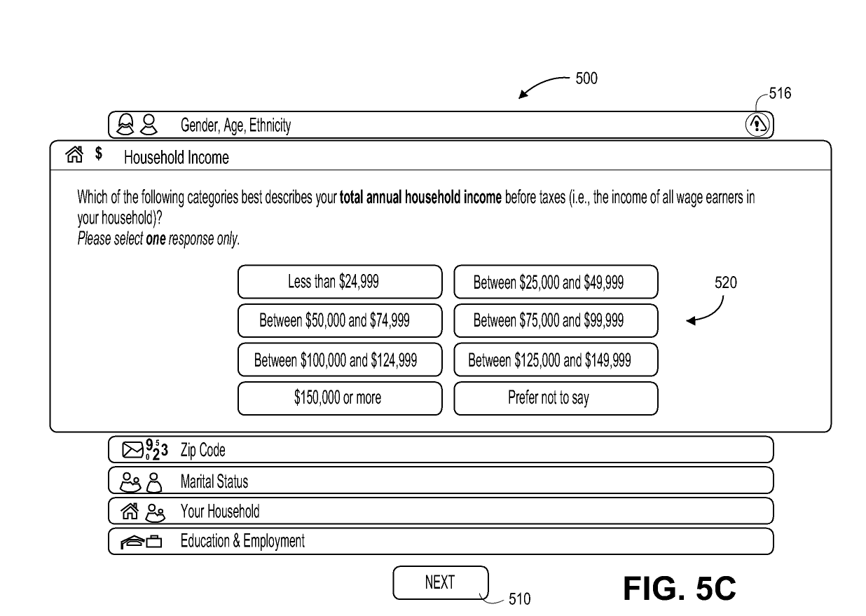

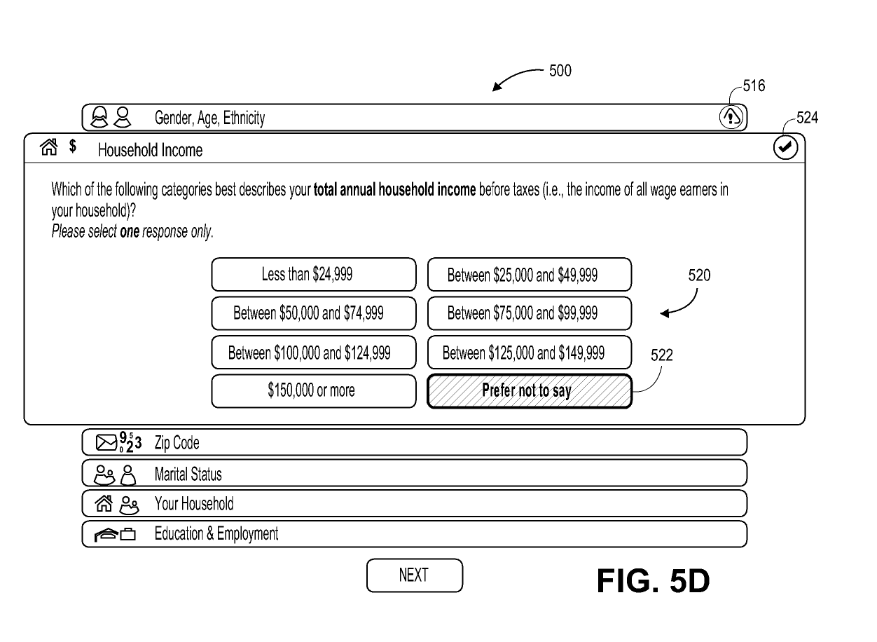

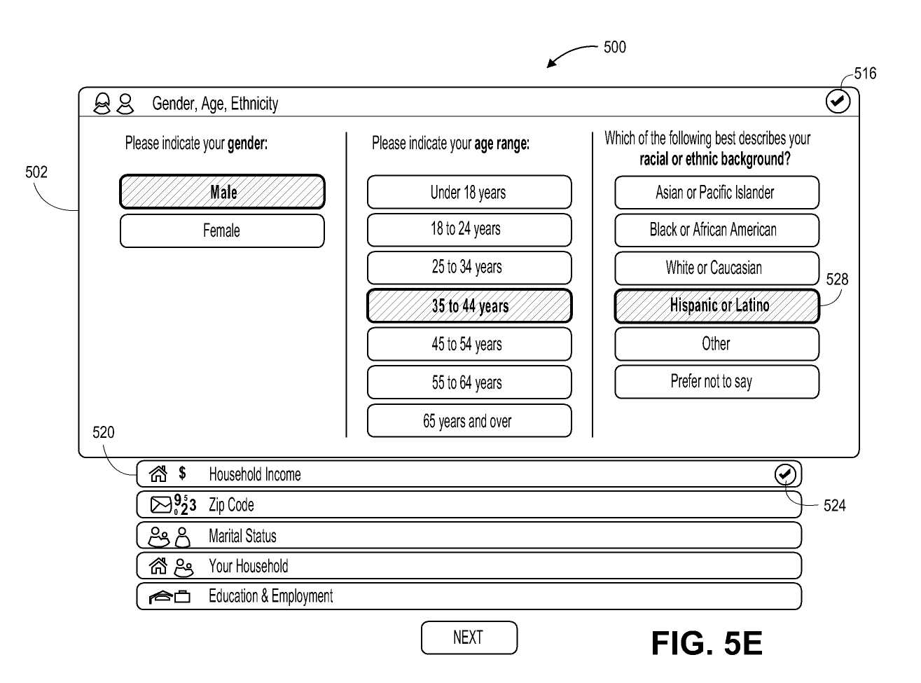

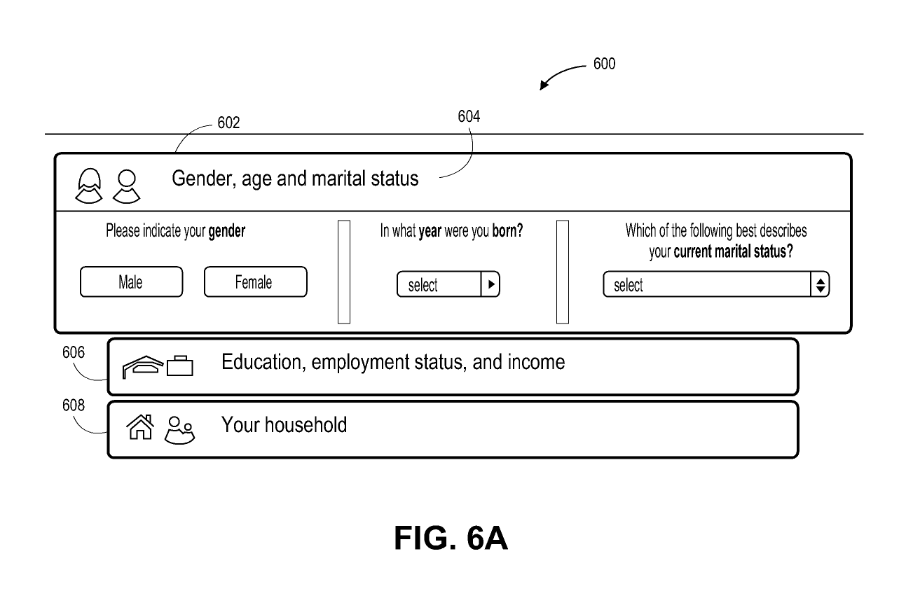

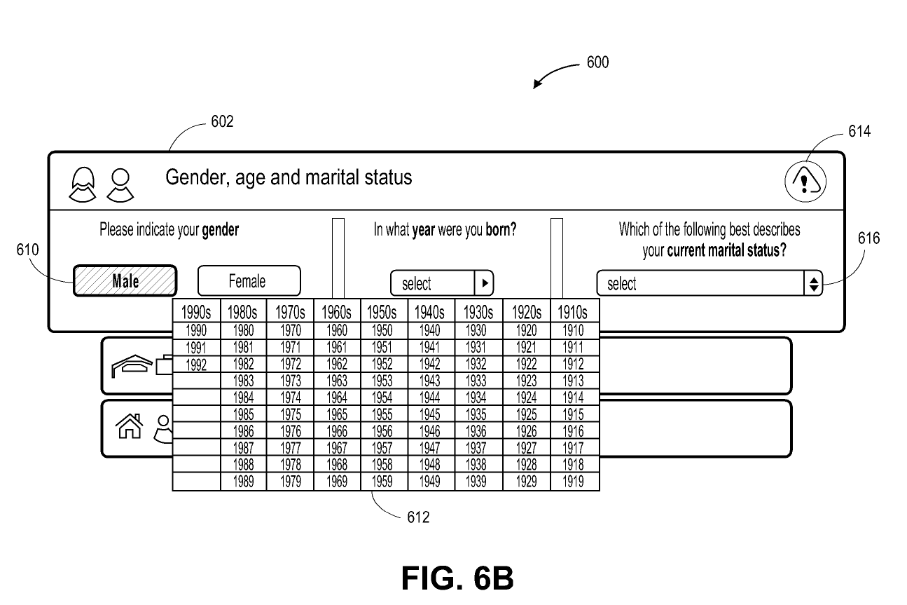

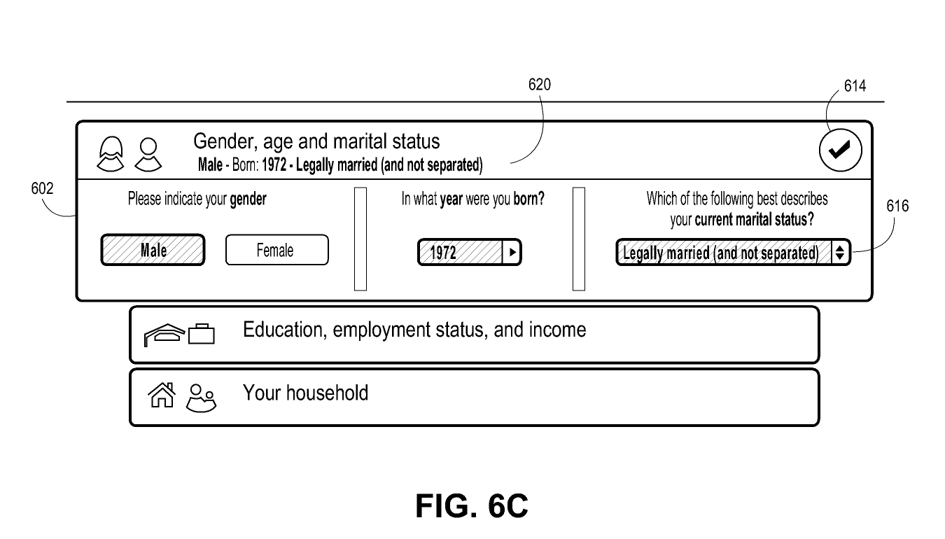

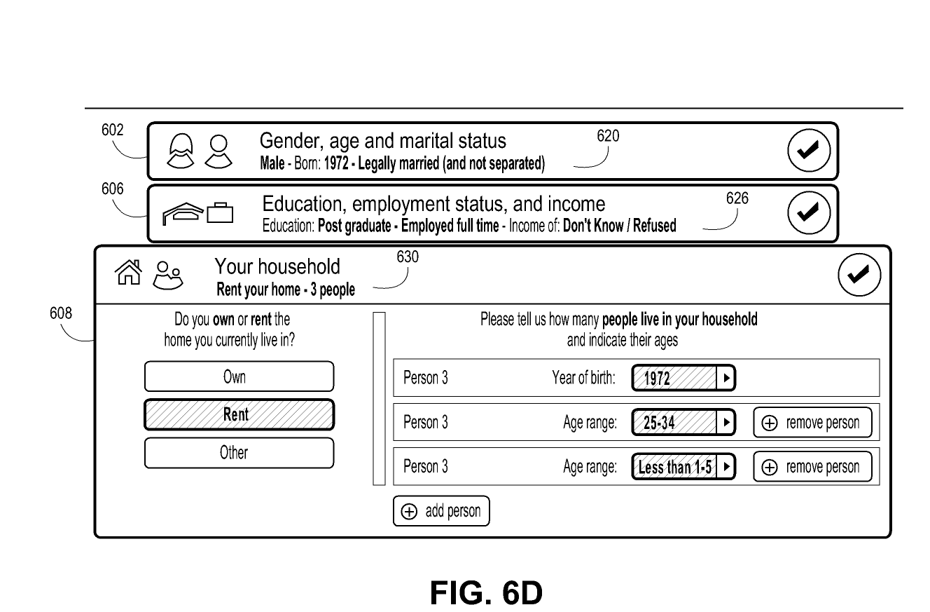

The content and control object 304 may also define type restrictions 406. Type restrictions 406 may be associated with certain of the thematically-related questions 302 in the panel 208. The type restrictions 406 may impose restrictions on the type of data that may be inputted by survey respondents by limiting the acceptable input to specific formats. For example, if a survey question asks for a phone number, the acceptable input may be limited to the form “###-###-####”. In addition to defining type restrictions 406, the content and control object 304 may also include state definition data 408. State definition data 408 is data which defines the various states that a panel 208 may enter. In one embodiment, the panel may enter an expanded state in which questions are shown to the survey respondent, while the remaining panels (which may be part of a tiled panel display) are in an unexpanded state which hides the detailed contents of the panel. The expanded and unexpanded states associated with the panels 208 are discussed in more detail below with reference to FIGS. 5 and 6. State definition data 408 may also include other data indicative of the state of a particular panel.

FIGS. 5A-5E provide examples of the behavior and configuration of panels which are displayed as tiled controls to survey respondents according to one particular embodiment. Starting with FIG. 5A, an example of a user interface 500 which is generated by the survey module 112 is provided. As shown, the user interface 500 includes a panel 502 in an expanded state, and several other panels 508 in an unexpanded state. As discussed above, expanded panel 502 is presented so that the survey respondent is able to view and answer a series of thematically-related questions, while the unexpanded panels hide their question-related information from the user. Although this and other embodiments described herein relate to grouping questions thematically, it is to be appreciated that other types of question groupings may also be utilized. In the example shown in FIG. 5A, the theme of the panel is displayed in the header area 504 and in this case is titled “Gender, Age, Ethnicity.”

The header area 504 also includes icons which are related to the type theme associated with the expanded panel 502 shown in the user interface 500. The body area 506 of the expanded panel 502 presents the thematically-related questions 302 which collectively form a meta-question, which, as discussed above may be received from a question array 210. Each individual question in the meta-question includes user-selectable responses which allow the survey respondent to provide their answer. As shown, each of the three questions is related to the theme presented in the header area 504 of the panel 502. The user interface 500 also includes a “Next” button 510. The “Next” button 510 is shown as not selectable. In some embodiments, the “Next” button is inactive until each of the questions in each of the panels 502 and 508 has received a proper response.

FIG. 5B shows the user interface 500 from FIG. 5A after a survey respondent has answered the first two questions, but not the third question. As shown, the first question relating to the gender of the survey respondent has been answered by a selection of the “Male” selection button 512. The next question relating to the age range of the survey respondent has been answered by a selection of the “35 to 44 years” selection button 514. As noted above, the panel 502 may include a progress indicator which provides a visual indicator of whether each of the questions in a panel has been answered. In this particular embodiment the panel 502 may be configured to generate a completion indicator 516 in the upper right hand corner indicating that the meta-question has not been answered because there are individual questions that still need to be answered by the survey respondent. Alternatively, the completion indicator 516 may instead be a progress indicator which provides a measure of how much of the survey has been completed, e.g., “2 of 3 topics completed.”

One advantage of presenting thematically-related questions as meta-questions in panels is that survey respondents are able to easily ascertain the theme associated with the panels (including those in unexpanded states) by observing the panel titles and move to answer questions in other panels with relative ease. FIG. 5C illustrates how a survey respondent may skip questions and move from one panel to a different panel. As shown, the user has selected the second panel with the theme “Household Income.” The “Household Income” panel includes a single question relating to the household income of the survey respondent. Thus, selection of one of the responses to this question will complete the panel.

As a result of the selection, the “Household Income” panel 520 is placed in an expanded state, while the previously selected panel associated with “Gender, Age, Ethnicity” to be placed in an unexpanded state. Although the “Gender, Age, Ethnicity” panel is no longer in the expanded state, it is to be appreciated that the completion indicator 516 associated with the panel is still visible to the survey respondent, thereby providing a visual indication that the questions related to “Gender, Age, Ethnicity” still need to be completed. The “Next” button 510 remains unavailable for user selection, as additional questions remain to be answered among the panels.

Turning now to FIG. 5D, the user interface 500 is shown with the single question presented in the “Household income” panel 520 as having received a user selection of the button 522 labeled “Prefer not to say.” As a result of the selection of an answer, the progress indicator 524 associated with the “Household income” panel 520 becomes a check mark indicating that the meta-question associated with the panel has been completed, and no further user action is necessary on the “Household income” panel 520.

FIG. 5E provides an example of how a survey respondent may return to a panel to complete questions in that panel. As shown, the survey respondent has again selected the “Gender, Age, Ethnicity” panel 502 which results in its placement in an expanded state. The “Household Income” panel 520 is reduced to an unexpanded state, but the progress indicator 524 remains to provide a visual indication that the panel 520 has been completed. The survey respondent has selected the “Hispanic or Latino” button 528 as the answer to the third question in the “Gender, Age, Ethnicity” panel 502. Because providing an answer to this question completes the meta-question for the “Gender, Age, Ethnicity” panel 502, its completion indicator 516 is also updated to indicate completion of this part of the survey. At this point, the survey recipient may select any of the other panels and answer those questions in a similar manner.

As noted previously, in certain embodiments, an ability to generate a summary display of survey response data in an aggregate format is provided. The aggregate format may be a pseudo-sentence which summarizes answers given to a series of thematically related questions in a panel 208. By providing a summary display of response data, a survey respondent is able to more easily verify the accuracy and completeness of their answers prior to submitting their survey response. FIGS. 6A-6E provide examples of the use of summary display of response data in accordance with certain embodiments.

Turning to FIG. 6A, an example of a user interface 600 including three panels 602, 606, and 608 is provided. The top panel 602 is shown as being in an expanded state an includes a thematic grouping of three questions relating to “Gender, age and marital status” into a single meta-question as shown in the header area 604 of the panel 602. As shown in FIG. 6A, none of the individual questions have yet been answered by the survey respondent.

As discussed above, content and control object 304 for each panel 208 may also define type restrictions 406. Type restrictions 406 may be associated with certain of the thematically-related questions 302 in the panel 208. The type restrictions 406 may impose restrictions on the type of data that may be inputted by survey respondents by limiting the acceptable input to specific formats. FIG. 6B provides one example of how different data types may be presented to a survey respondent. As shown, the first individual question of the meta-question has been answered by the survey respondent with a selection of the “Male” button 610. The second individual question asks the survey respondent for the year of his birth. In this example, a type restriction 406 has been included in the panel which restricts allowable input to the years provided in the table. Because no selection has been made with respect to the second question 612 and third question 616, the progress indicator 614 indicates that work remains to be done to complete the meta-question associated with the first panel 602.

Turning now to FIG. 6C, the meta-question for the first panel 602 (which includes three individual questions relating to the “Gender, age, marital status” theme) has been fully answered. As shown, the progress indicator 614 has been modified to indicate that the meta-question has been completed. Moreover, in the heading area, a summary of the inputted meta-question response has been generated by the panel object 206 which provides an accurate summary of the information provided by the inputted answers. In this example, the survey respondent has answered the first question “Please indicate your gender” by selecting the “Male” answer option. In response to the question regarding the year of birth, the survey respondent has selected the answer “1972.” Finally, in response to the question seeking the best description of the marital status, the survey respondent has selected the “Legally married (and not separated)” option. As a result of those selections, the summary 620 of the meta-question response is generated and displayed to the survey respondent, providing an easy and quick way to review the answers before moving on to the next panel. In some additional embodiments, the sentence could be built up as the user answers individual questions. Thus, as each individual question is answered, the pseudo-sentence may be partially generated.

Turning to FIG. 6D, each of the meta-questions associated with the three panels 602, 606, and 608 has been now answered. As a result, the progress indicated in the upper right corner of each panel indicates that the meta-questions have been completed. Additionally, the generated summary for each meta-question response remains viewable. This allows the survey respondent to easily review their prior answers. In particular, the generated summary 620 associated with the first panel is displayed by the first panel in the unexpanded state. Similarly, the generated summary associated with the second panel 606 is also displayed while in the unexpanded state. The third generated summary 630 associated with the third panel 608 (which remains in the expanded state) is also viewable to provide an easy summary of the survey responses.

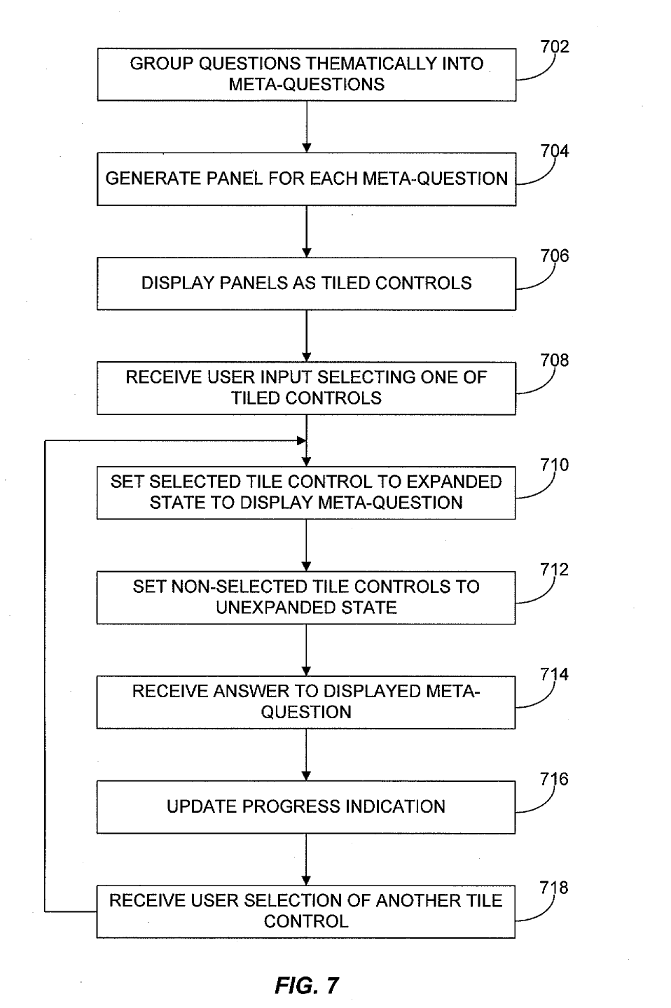

As noted previously, certain embodiments disclosed herein involve methods for a generating and conducting an online survey by a computer system such as survey system 100 from FIG. 1. FIG. 7 is a flowchart illustrating a process by which the survey system 100 may generate and conduct an online survey. The process begins at block 702 where questions are grouped thematically into meta-questions. As noted previously in connection with FIGS. 2A and 2B, the panel manager 207 may be configured to generate these groupings. Once the meta-questions have been devised, the process then moves to block 704, where a panel is generated for each of the meta-questions. Once the panel has been generated for the meta-questions, the panels are then displayed to the user. As noted above, the survey may be delivered to the user via a computer network such as the Internet. In this particular example, the panels are displayed as tiled controls such as those shown in FIGS. 5 and 6 above.

Next, the process moves to block 708, where the survey system 100 receives a user input selecting one of the tiled controls. Upon receiving of the user input, the selected tiled control is set to its expanded state to allow user interaction with its associated meta-questions at block 710. Although the process described in blocks 708 and 710 shows that placing the panel in its expanded state is due to the user input, it is to be appreciated that in some embodiments, expansion of the one of the panels may be automatic when the page loads into memory. To allow the survey respondent to focus on the selected control, the remaining tiled controls are set for the unexpanded state at block 712. Next, at block 714, the system 100 may receive an answer to some portion of or all of the meta-question associated with the selected tiled control. The process then moves to block 716, where the progress indicator associated with the selected tiled control is updated. As noted previously, if the entire meta-question has been answered the progress indicator may be modified to indicate that the meta-question has been completed. On the other hand, of only some of the questions included in the meta-question have been answered, the progress indicator may be updated to indicate that additional work is necessary to complete the current tiled control. Once the progress indicator has been updated, the system receives a user selection of another tile control at block 718, and it then returns to block 710.

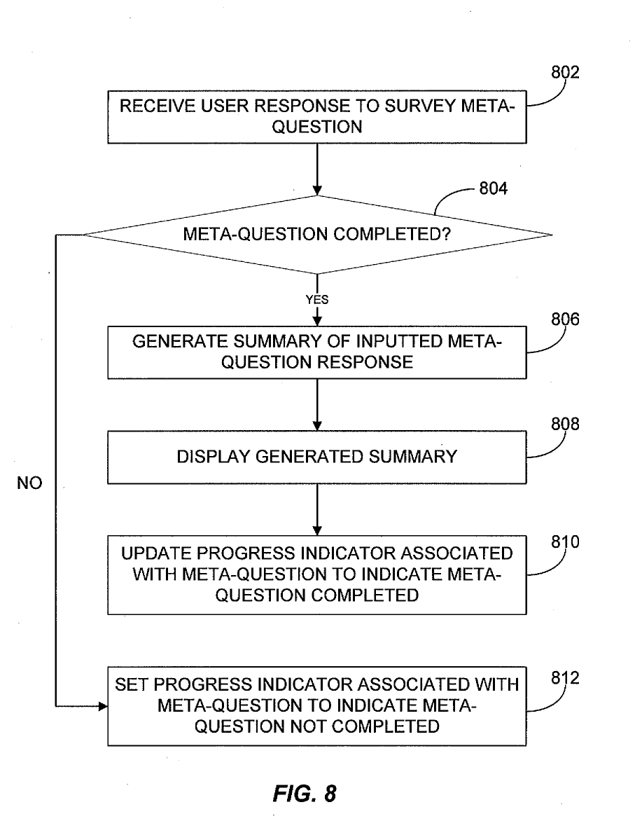

As further noted above, additional embodiments involve generating summaries of survey responses and displaying those generated summaries in their associated panels. FIG. 8 is a flowchart of a process by which a summary of a response to a meta-question is generated for display to a user. The process begins at block 802, where the survey system receives a response to a survey meta-question. As noted above, the response to the meta-question may be inputted by a survey respondent over a computer network connection to the survey system 100. The process then moves to decision block 804, where it is determined whether the meta-question has been completed, or if there remain individual questions to answer by the survey respondent. If at decision block 804, it is determined that the meta-question has not been completed, the process moves to block 812 where the progress indicator associated with the meta-question is updated to indicate that the meta-question has not yet been completed. If it is determined that the meta-question has been completed at decision block 804, the process then moves to block 806, where a summary is generated of the inputted meta-question response. Once the summary has been generated, the process then moves to block 808, where the system displays the generated summary and then moves to block 810 where it sets the progress indicator to indicate that the meta-question has been completed.

Those of skill will recognize that the various illustrative logical blocks, modules, circuits, and algorithm steps described in connection with the embodiments disclosed herein may be implemented as electronic hardware computer software or combinations of both. To clearly illustrate this interchangeability of hardware and software, various illustrative components, blocks modules, circuits, and steps have been described above generally in terms of their functionality. Whether such functionality is implemented as hardware or software depends upon the particular application and design constraints imposed on the overall system.

Skilled artisans may implement the described functionality in varying ways for each particular application, but such implementation decisions should not be interpreted as causing a departure from the scope of the present invention. The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CDROM, or any other form of storage medium known in the art. An exemplary storage medium is coupled to the processor such the processor can read information from and write information to, the storage medium. In the alternative, the storage medium may be integral to the processor.

The processor and the storage medium may reside in an ASIC. The ASIC may reside in a user terminal or some other type of device. In the alternative the processor and the storage medium may reside as discrete components in a user terminal.

What is claimed is:

1. A computer-implemented method for presenting survey questions to survey respondents, the method comprising:
grouping questions thematically into a plurality of meta-questions;
generating a plurality of tiled controls which provide access to each meta-question, the tiled controls having an expanded view and an unexpanded view;
receiving an input selection of one of the tiled controls;
setting the selected tiled control to the expanded view to display its associated meta-question for user response; and
setting the non-selected tiled controls to the unexpanded view.

2. The method of claim 1, wherein at least one of the generated tiled controls includes a title indicative of the meta-question to which it provides access.

3. The method of claim 2, wherein at least one of the generated tiled controls further comprises a completion indicator, the completion indicator comprising a visual element indicative of whether the meta-question has been fully answered.

4. The method of claim 3, further comprising:
receiving data indicative of the user response to the meta-question;
generating a summary of the inputted meta-question response; and
modifying the completion indicator to indicate that the meta-question has been fully answered.

5. The method of claim 4, further comprising:
receiving data indicative of a user selection of another of the plurality of tiled controls; and
in response to the user selection of the another one of the plurality of tiled controls:
setting the newly selected tiled control to the expanded state; and
setting the previously selected tiled control to the unexpanded state.

6. The method of claim 5, wherein setting the previously selected tiled control to the unexpanded state comprises:
retrieving the generated summary of the inputted meta-question response; and
displaying the generated summary on the unexpanded tiled control.

7. The method of claim 6, wherein the generated summary comprises a pseudo-sentence indicative of the inputted meta-question response.

8. The method of claim 6, wherein the generated summary comprises a graphical element indicative of the inputted meta-question response.

9. An online survey system comprising:
data storage configured to store data indicative of a plurality of survey questions, wherein at least some of the plurality of survey questions are thematically grouped into meta-questions;
a computing device in communication with the data storage and configured to generate a plurality of displayable panels having an expanded state and an unexpanded state, the panels each corresponding to one of the meta-questions and configured to:
enter an expanded state and provide access to its meta-question in response to a user selection of the panel;
receive data inputs indicative of responses to the meta-question;
generate summary data indicative of the received responses;
display the summary data on the panel in both an expanded and unexpanded state;
update a completion indicator associated with the panel based on the user input; and
enter an unexpanded state when a selection of another panel is received by the online survey system.

10. The online survey system of claim 9, wherein at least one of the generated displayable panels includes a title indicative of the meta-question to which it provides access.

11. The online survey system of claim 10, wherein at least one of the generated displayable panels further comprises a completion indicator, the completion indicator comprising a visual element indicative of whether the meta-question has been fully answered.

12. The online survey system of claim 11, wherein the computing device is further configured to:
receive data indicative of the user response to the meta-question;
generate a summary of the inputted meta-question response; and
modify the completion indicator to indicate that the meta-question has been fully answered.

13. The online survey system of claim 12, wherein the computing device is further configured to:
receive data indicative of a user selection of another one of the plurality of tiled controls; and
in response to the user selection of the another one of the plurality generated panels:
set the selected another one of the plurality of tiled control to the expanded state; and
set the previously selected tiled control to the unexpanded state.

14. The online survey system of claim 13, wherein the computer device is further configured to set the previously selected tiled control to the unexpanded state by:
retrieving the generated summary of the inputted meta-question response; and
displaying the generated summary on the unexpanded tiled control.

15. The online survey system of claim 14, wherein the generated summary comprises a pseudo-sentence indicative of the inputted meta-question response.

16. The method of claim 14, wherein the generated summary comprises a graphical element indicative of the inputted meta-question response.
